(19) United States
(12) Patent Application Publication
(10) Pub. No.: US 2025/0369570 A1
(43) Pub. Date: Dec. 4, 2025

(54) OPTIMIZED GAS DELIVERY SYSTEM

(71) Applicant: Gasokay ApS, Allerød (DK)

(72) Inventors: Søren Xerxes Frahm, Horsens (DK); Lasse Jensen, Horsens (DK); Tom Lundquist, Hørsholm (DK)

(73) Assignee: Gasokay ApS, Allerød (DK)

(21) Appl. No.: 18/874,237

(22) PCT Filed: Jun. 16, 2023
(86) PCT No.: PCT/EP2023/066287

§ 371 Date: Dec. 12, 2024

(30) Foreign Application Priority Data
Jun. 17, 2022 (EP) 22179612.1

(51) Int. Cl. F17C 7/02

(52) U.S. Cl. CPC F17C 7/02; F17C 2205/0146; F17C 2205/0326; F17C 2205/0385; F17C 2221/035; F17C 2223/0153; F17C 2250/03; F17C 2250/0421; F17C 2250/043; F17C 2250/0439; F17C 2250/0443

(57) ABSTRACT

A gas delivery system, a valve system and a method for optimization of residual gas usage in a gas delivery system. The gas delivery system includes; a first and second gas containers; a threeway valve in fluid communication with the first and second gas containers, the valve configured to change position between a first valve position, wherein gas is supplied from the first container and a second valve position, wherein gas is supplied from the second container, a sensor device adapted to measure a first sensed property of the first gas container, a control unit configured to receive the first sensed property, and configured to change the position of said valve from the first to the second valve position and back to the first valve position; wherein control unit is adapted to maintain the valve in the second valve position for a re-vaporization period of time being predefined and/or based on a second sensed property.

### FIELD OF THE INVENTION

The invention relates to the field of gas delivering systems for optimized consumption of residual gas. Specifically, it relates to a method for optimization of residual gas consumption in a gas delivery system comprising at least two gas containers.

The invention further relates to a gas delivery system for optimization of residual gas consumption.

### BACKGROUND OF THE INVENTION

Gas, especially liquid/liquefied petroleum gas (LPG), is used for numerous applications including heating, cooling, and cooking in places, most often where a steady supply of electricity cannot be ensured. This may be for outdoors grilling, on boats out at sea, at domestic applications or in camper-caravans, where the gas is often used for several appliances such as a heater an absorption fridge or a gas grill.

An LPG-container (also known as a LPG cylinder bottle) stores LP-gas under high pressure, wherein 80% is of the LP-gas is stored as a liquid phase and 20% as gas phase when initial filled. The LPG gas vapor is held in the top of the LPG bottle and the liquid LPG at the bottom due to gravity. The LPG stays liquid because it is under pressure in the gas container.

Since the boiling point of LPG is below room temperature, LPG will evaporate quickly at normal temperatures and pressures and is therefore supplied in pressurized gas containers. They are typically filled at maximum 80% of their capacity to allow for thermal expansion of the contained liquid and a maximum pressure of 16 bar. The pressure at which LPG becomes liquid is called its vapor pressure. To boil and start vaporization, the liquid LPG draws heat from the wetted walls of the LPG cylinder bottle which, in turn, works by getting heat from the ambient air. Wall surface touched by gas phase cannot transfer heat.

To reduce the high pressure inside the gas container to a usable level, the gas is often passed through a gas regulator connected to the gas container to decrease the pressure. Hereby the regulator can deliver gas at a desired supply pressure required by a receiving device such as gas appliances.

When gas is consumed from the gas container the maximum flow it can provide is typical between 0.7 and 2.0 kg/h depending on the gas type, ambient temperature, and time.

If the consumption exceeds 30 minutes of duration a maximum of 0.7 kg/h can be withdrawn from one gas container. The limitation is defined by the maximum energy transfer through the wetted surface of the gas container. The time depends of actual ongoing and filling rate of the gas container.

Taking a gas grill as an example. The gas is under maximum 16 bar pressure in the gas container, and is thus preliminary liquid. The gas container is in fluid communication with the gas grill via the regulator and a tube for transporting the gas.

As the pressure is released when the regulator is opened and consumption starts, the liquid evaporates quickly and turns into gas phase. More specifically the equilibrium between gas and liquid phase in the container is disturbed and new liquid is thus evaporated to reestablish the equilibrium.

The regulator ensures that a fixed gas pressure is delivered when the gas is discharged from the gas container through the regulator and gas tube and onto the burners of the grill.

It is however difficult to detect when there is no more gas left in the container, and it is quite annoying to suddenly be without a steady supply of gas and heat in your gas grill, when you are in the mist of preparing a meal.

Therefor gas containers are often exchanged at the first sign of an unsteady flow.

An alternative is using two or more gas container and a manual or automatic changeover valve. Often cheaper in price, the manual changeover valve leaves it up to the user to switch the valve from directing gas from the empty cylinder to directing gas from the stand by full gas container. This means the valve will not automatically start using the full stand by gas cylinder, so the user may get an unsteady flow of gas.

The traditional automatic changeover valve working on pressure will automatically switch position from directing gas from an “empty” gas container to directing gas from a full stand by gas container when the mechanics of the valve registers a pressure below a certain threshold. Hereby interruptions in gas flow is limited. This usually happens at a preset threshold value of 0.7 bar.

Such manual and automatic valves are well known in the art.

But at this time, when the gas container is viewed as “empty”, since the pressure in the gas container is under the threshold, i.e. the value of 0.7 bar, there is actually still up to 1 kg of liquified gas left in the gas cylinder.

The amount of residual gas left in the container, when the changeover valves views the container as empty depends also on the ambient environment. But typically the container still have up to 10% liquified gas left inside.

It is due to the fact that the residual amount left in the gas container is at low pressure and with a much reduced wetted surface allowing heat to enter the liquid gas, that the new required vaporization can no longer keep up with the gas consumption (which of course is dependent on temp, bottle type and usage), and the cylinder is thus declared “empty” by the changeover valve and the valve switches to a new gas container.

Hereby an great deal of gas is not consumed and thereby waisted each time a single gas container is exchanged. This at the cost of the consumer who pays for a full gas container each time.

On this background it is an object of the invention to provide a gas delivery system, a valve, and a method for optimization of residual gas usage in a gas delivery system.

### SUMMARY OF THE INVENTION

According to a first aspect of the invention, the objects laid out in the background section may be achieved by a method for optimization of residual gas usage in a gas delivery system comprising; a first and a second gas container for supplying gas and an at least three-way valve in fluid communication with the first and second gas containers, the valve being operable to change position between a first valve position, wherein gas is supplied from the first container, and a second valve position, wherein gas is supplied from the second container, wherein the method comprises the steps of; measuring with a sensor device a first sensed property of the first gas container; receiving with a control unit the first sensed property from the sensor device; changing the position of said valve from the first valve position to the second valve position based on said first sensed property; maintaining the valve in the second valve position for a re-vaporization period of time, said period being predefined and/or based on a second sensed property from the sensor device, and changing the position of the valve back to the first valve position after the re-vaporization period.

By providing the above described method, it is possible to detect when the gas pressure and/or gas flow from the first gas container falls below a minimum level that the receiving consumption appliance consumes at the present time, and then give the almost empty gas container a pause (referred to as a re-vaporization period in this specification)—a time to rebuild pressure and gas flow capability, whilst gas is delivered from the second gas container, which then enables the first gas container to again deliver stable pressure and flow for some time even at low liquified gas levels, thereby optimizing the usage of the residual liquified gas in the first gas container.

The invention takes advantage of the advanced control to manage shifting back and forth between the two gas containers. As a result it is possible to use up almost all the gas at optimal pressure and flow from the first gas container by switching back and forth between valve positions and thus the containers a number of times until almost all the liquified gas has evaporated and been consumed.

This sequence of consumption periods and re-vaporization periods is repeated until almost all liquified gas in the first gas container has evaporated and been consumed. Due to this controlled method all gas outtake volume is consumed at optimum gas pressure and optimum flow servicing the receiving gas appliances best possible.

In an embodiment the control unit is a separate remote control device adapted to use an App, Bluetooth, or a GSM, Wi-Fi or LoRa, to transmit the sensed properties to a cloud or other external processor device ex. a PC

In the context of this application the wording gas container or bottle or cylinder are all used for describing any means or device that is cable of containing a liquified gas. Throughout the present specification the definition “gas container” or simply just “container” is used. It is understood that this refers to both a container of gas and a container of liquified gas, such as for example LPG or DME (dimethyl ether) or mixes of those. In each instance the container will physically dispense a gas, whether the contents of the container itself is a gas or a liquid or a combination thereof.

LPG is an acronym for either Liquefied Petroleum Gas or Liquid Petroleum Gas. It is also in some documents called LPG Gas, LP Gas, Propane, Butane, BBQ Gas, Camping Gas or Autogas, as well as all of the other specific gas names.

In an embodiment of the invention changing of the valve to and from the first valve position and/or the second valve position is remotely controlled, preferably wirelessly controlled. This may be done via AI, Bluetooth, the internet, or the like.

According to another aspect of the invention, the present disclosure further involves a gas delivery system for optimization of residual gas usage, the system comprising; a first and a second gas container for supplying gas; an at least three-way valve in fluid communication with the first and second gas containers, the valve being operable to change position between a first valve position, wherein gas is supplied from the first container and a second valve position, wherein gas is supplied from the second container; a sensor device adapted to measure a first sensed property of the first gas container; a control unit configured to receive the first sensed property from the sensor device, and being adapted to change the position of said valve from the first valve position to the second valve position based on said first sensed property; wherein the control unit is adapted to maintain the valve in the second valve position for a re-vaporization period of time, said re-vaporization period being predefined and/or based on a second sensed property from the sensor device, wherein the control unit is further adapted to change the position of the valve back to the first valve position after the re-vaporization period.

By having said system it is possible to provide an improved emptying of the first gas container, so that as much as the gas is used before the container is replaced.

According to yet another aspect of the invention, the present disclosure further involves a valve system for optimization of gas usage in a gas delivery system, said valve system comprising; an at least three-way valve comprising a first inlet for receiving gas from a first container, a second inlet for receiving gas from a second container, an outlet for directing the gas from the first and/or second inlet to a receiving device, wherein the valve is adapted to change position between; a first valve position, such that gas may flow from the first container through the valve to the receiving device, and a second valve position, such that gas may flow from the second container to the receiving device, said valve being positioned in the first position, the valve system further comprising; a sensor device adapted to determine a first sensed property, such as gas flow, said first sensed property indicating if the flow of gas to the receiving device is below a predetermined level; a control unit adapted to change the position of said valve, so that in case the flow of gas is below the predetermined level, the control unit changes the position of the valve from the first valve position to the second valve position, so that gas is directed from the second container to the receiving device, wherein control unit is adapted to maintain the valve in the second valve position to allow vaporization of new gas inside the first container, so that when a predetermined re-vaporization period is reached, the control unit is adapted to change the position of the valve back to the first valve position, so that the newly generated gas in the first container may flow to the receiving device.

In an embodiment of the invention the control unit may be part of the changeover valve and/or built into the valve. Hereby it is possible to easily retrofit the valve and control unit to existing gas delivery systems, whereby the residual gas can be utilized.

It is to be understood that the embodiments described according to this invention may be used in combination with any of the above stated aspects of the invention.

In an embodiment of the invention the receiving device may be a gas burner, a stove, a refrigerator, a heating unit, or the like. Many know applications exists and are well known in the art.

In an embodiment of the invention the control unit may be built into a changeover valve and/or a weighing scale.

In an embodiment of the invention the sensor device is a weighing scale, preferably positioned under the first gas container, in order to determine a first sensed property, preferably a weight of the gas/liquid in the container, so as to determine if the flow of gas to the receiving device is below a predetermined level.

By viewing the first container as the primary container i.e. the one that is providing gas for the receiving unit, only one weight is needed, thereby reducing the cost for additional devices, but still being able to optimize usage of the residual gas in the first container. The second container will thus function as a buffer. Assuming that both containers are full from start, it is possible to change the valve position, so that gas is supplied from the second container, each time the first container is not able to provide sufficient gas flow. Hereby the first container is on pause whilst the residual liquified gas vaporizes into gas phase, so when the valve is changed back to the first valve position, the pressure in the first container is again high enough and sufficient volume of gas is stand by to provide sufficient flow of gas to the receiving unit—at least for a while. When there is another drop in flow and pressure, the valve may then again be switched to the second valve position.

When the first container is approximately empty, the user may move the second container to the weight, thereby making this the new first container, and then bring in a new full container to take place as the second, buffer container, and so on.

Hereby maximizing the use of any residual gas in every container.

In an embodiment the changeover valve is changed from the first valve position to the second valve position at least two times or more, preferably a plurality of times.

In an embodiment the changeover valve is changed from the second valve position to the first valve position at least two times or more, preferably a plurality of times.

In an embodiment the changeover valve is changed from the first valve position to the second valve position at least two times and said valve is changed from the second valve position to the first valve position at least two times.

In an embodiment the valve is preferably a three-way crossover valve, more preferred a three-way automatic crossover valve.

In another embodiment of the invention the sensor device comprises a second weight, preferably positioned under the second gas container, in order to determine a second sensed property, preferably a weight of the gas/liquid in the container, so as to determine if the flow of gas to the receiving device is below a predetermined level.

In an embodiment of the invention the sensor device is a pressure sensor and/or a flow sensor. In an embodiment of the invention the sensor device comprises two pressure sensors and/or two flow sensors and/or a pressure sensor and a flow sensor.

n an embodiment the sensor is arranged at the outlet of the changeover valve. In another embodiment the sensor is arranged at the receiving device. In yet another embodiment the sensor is arranged at a flow path between the changeover valve and the receiving device. In an embodiment the sensor is arranged at a flow path between the first container and the changeover valve. In an embodiment the sensor is arranged at a flow path between the second container and the changeover valve.

In an embodiment one sensor is arranged at a flow path between the first container and the changeover valve, and another sensor is arranged at a flow path between the second container and the changeover valve.

By providing a pressure sensor in connection with the system, the need to take temperature into account is alleviated, since the sensor will provide real time information on; when the flow of gas from the first container is insufficient, so that the changeover valve should be changed from the first valve position to the second valve position and hereafter whether enough liquified gas has vaporized in the first container, so that the valve may again be turned back from the second valve position to the first valve position.

In an embodiment the system further comprises a temperature sensor.

By providing an indication of the temperature surrounding the gas cylinder(s) it is possible to better calculate how much time is need for vaporization of residual liquified gas.

In an embodiment the temperature sensor is adapted to measure a temperature of the first gas container and/or the second gas container.

In an embodiment the temperature sensor is a strip sensor positioned substantially along the length of the gas container.

In an embodiment the system comprises a weighing scale and a pressure sensor, preferably the pressure sensor is arranged at the outlet of the changeover valve.

In an embodiment the pressure sensor is arranged after a regulator.

The flow rate may be used to calculate cumulative measured flow rate representative of the cumulative amount of gas supplied from the gas container through the tube.

The system of the present invention may be configured for a receiving device with two gas containers; for a receiving device with more than two gas containers.

In an embodiment the valve is adapted to be arranged in a third valve position so that no gas may flow from the first gas container and/or the second gas container through the valve and onto the receiving unit.

### BRIEF DESCRIPTION OF THE DRAWINGS

The invention will be described in more detail below by means of nonlimiting examples of embodiments and with reference to the schematic drawings, in which:

FIGS. 1a-c show a schematic overview of a gas delivery system at different stages from a cross-sectional side view;

FIG. 2 show a schematic overview of another embodiment of a gas delivery system from a cross-sectional side view;

FIGS. 3a-d show different third embodiments of a gas delivery system with a sensor from a cross-sectional side view;

FIGS. 4a-b show different fourth embodiments of a gas delivery system with a control unit from a cross-sectional side view;

FIG. 5 show a fifth embodiment of a gas delivery system with a separate control unit from a cross-sectional side view.

FIG. 6 show a schematic overview of an embodiment of a gas delivery system with a valve in a third position.

FIG. 7 show another embodiment of a gas delivery system with a cloud based control unit.

### DETAILED DESCRIPTION OF THE INVENTION

In the following, embodiments of the invention will be described in further detail. Each specific variation of the features can be applied to other embodiments of the invention unless specifically stated otherwise. Note that for illustrative purposes the dimensions, especially thickness and/or size of the different elements shown may be exaggerated.

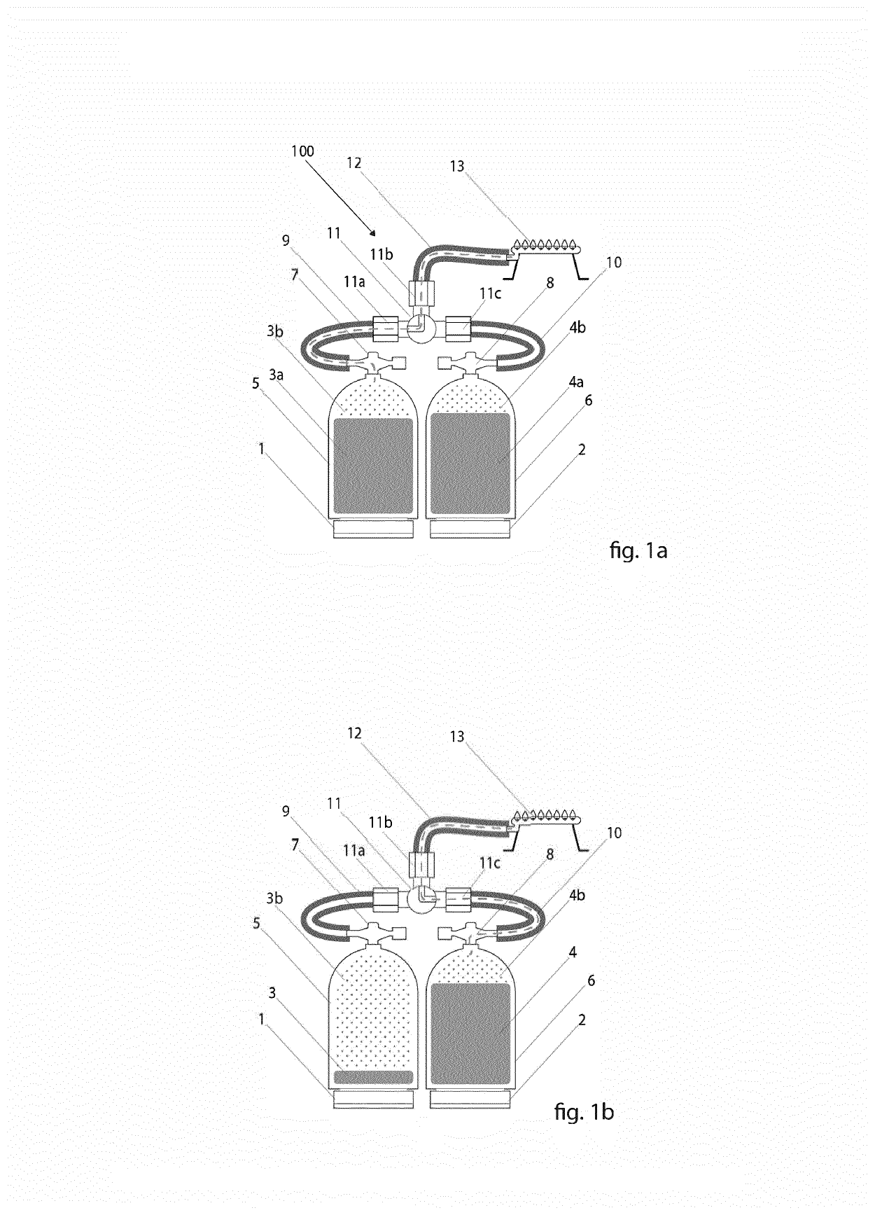

Turning first to FIGS. 1a-c a first embodiment of a gas delivery system 100 of the invention at different stages is shown from a cross-sectional side view.

FIG. 1a-c shows a gas delivery system 100, and/or shows a method according to the invention.

The gas delivery system 100 comprises a first gas container 5 and a second gas container 6.

The first gas container 5 is adapted to store a product, here shown as liquified gas 3a and gas 3b in gas phase, therein. Likewise, the second gas container 6 is adapted to store a product, here shown as liquified gas 4a and gas 4b in gas phase, therein.

A valve, specifically a three-way automatic crossover valve is provided to direct a flow of gas from the containers 5, 6 to a receiving device 13, here shown as a gas burner.

The valve 11 is at least operable between a first valve position, as shown in FIG. 1a, to enable a supply of gas from the first gas container 5 and a second valve position, as shown in FIG. 1b, to enable a supply of gas from the second container 6.

The gas container may be a gas cylinder.

The change from the first valve position to the second valve position may occur when flow from the first container 5 drops in flow and/or pressure.

The change from the first valve position to the second valve position may occur automatically, e.g. when a predetermined threshold value is reached, such as flow rate and/or pressure.

The gas delivery system comprises a sensor device 31 (not shown since it may be integrated in a part of the system).

The sensor device is adapted to detect a first sensed property, such as gas flow, said first sensed property indicating if the flow of gas to the receiving device 13 is below a predetermined level.

The sensor device may include a sensor for sensing the configuration of the valve (for example a magnetic field sensor such as a Hall effect sensor), a weighing scale for measuring a weight of the gas container, a temperature sensor for measuring a temperature of the gas container, wherein the detected sensed property generated by the sensor device is representative of the temperature of the gas container, and/or a flow rate sensor for measuring a flow rate in a supply line 9, 10 through which gas is supplied by the first and/or second container 5, 6.

The gas delivery system 100 further comprises a control unit 32 that is configured to receive a first sensed property related to the gas container 5, 6.

The control unit 32 may comprise one or more processors for receiving sensed property(s) from the sensor device 31 and performing an action as a reaction to the received sensed properties, such as changing the position of the valve.

The control unit 32 may also be adapted to determine a status of the gas container(s), preferably on the basis of the information received from the sensor device 31.

The control unit 32 may also comprise a communications module for, preferably wireless communication, with a remote server.

The control unit further comprises a power management system for providing power to the one or more processors and to the communications module.

The system 100 further comprises a first regulator 7 for regulating the flow of gas supplied from the first container 5 through a first tube 9 to the valve 11. The first tube 9 is connected to a first valve inlet 11a on the valve 11.

The system 100 further comprises a second regulator 8 for regulating the flow of gas supplied from the second container 6 through a second tube 10 to the valve 11. The second tube 10 is connected to a second valve inlet 11b on the valve 11.

A third tube 12 is connected at one end to an outlet 11c on the valve and at another end to the receiving unit 13 so as to supply gas from the valve to the receiving unit.

The system 100 further comprises a sensor device. In FIGS. 1a-d the sensor device comprises a first weighing scale 1 and a second weighing scale 2.

The first scale 1 is positioned under the first container 5, so as to be able to detect a first sensed property, specifically a weight of the container 5 and/or a weight of the content 3a,b of the container 5.

The second scale 2 is positioned under the second container 6, so as to be able to detect a second sensed property, specifically a weight of the container 6 and/or a weight of the content 4a,b of the container 6.

The system 100 further comprises a control unit adapted to control a change of the position of the valve 11.

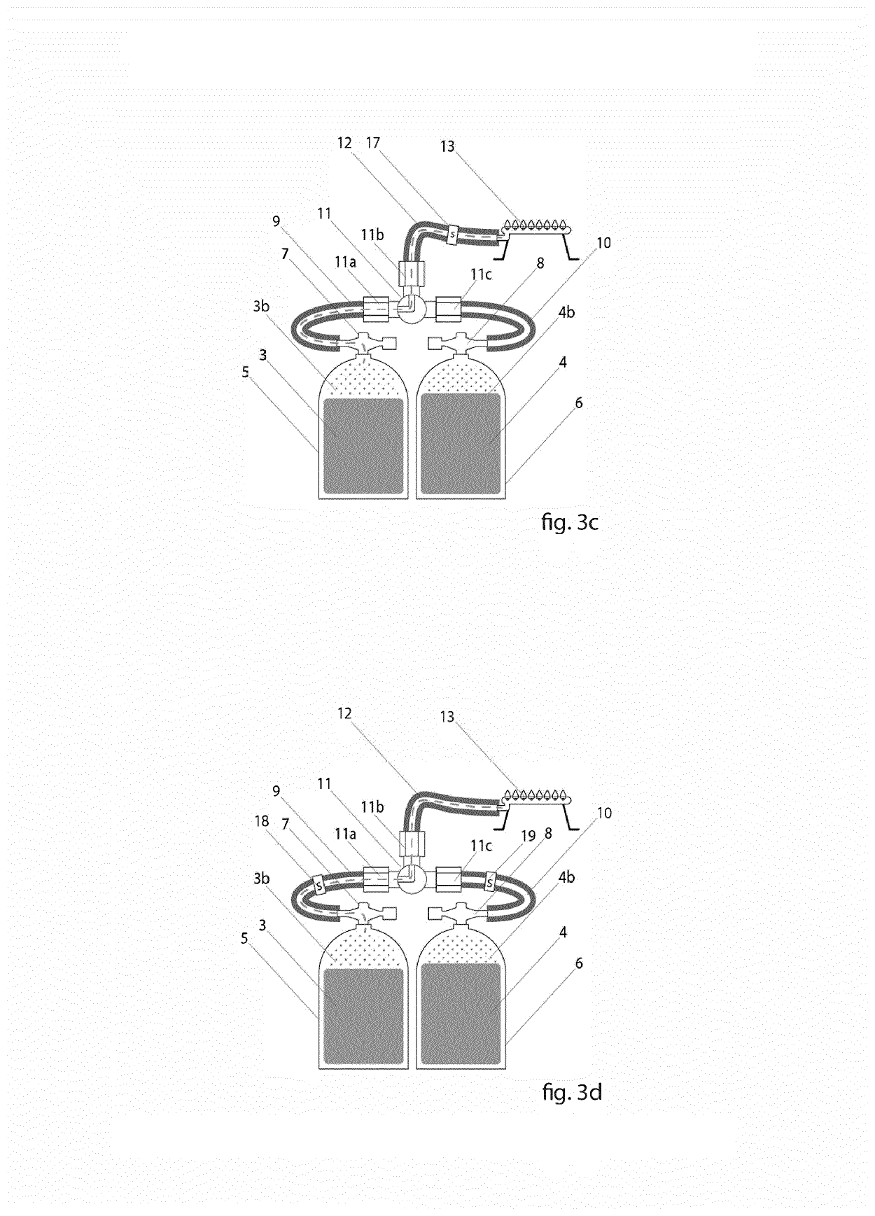

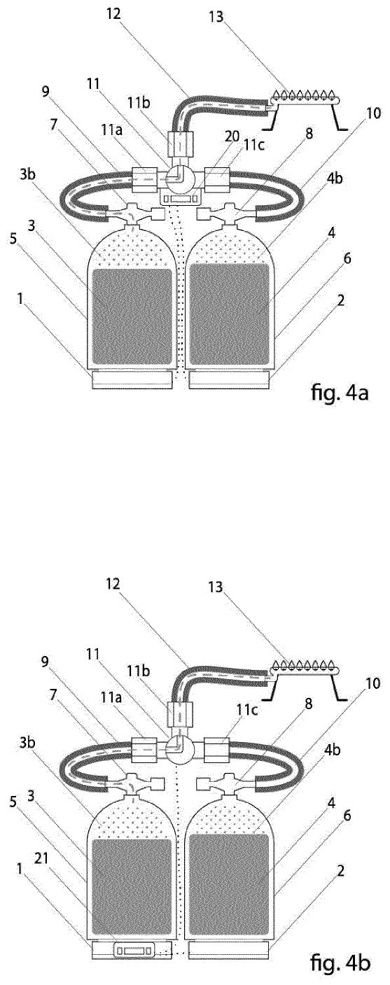

In an embodiment as seen of FIG. 4a the control unit 20 is part of the valve 11. In another embodiment as seen on FIG. 4b the control unit 21 is part of the weighing scale 1. In yet another embodiment as seen on FIG. 5 the control unit 22 is a separate unit such as a computing device.

In another embodiment the control unit may be a separate control unit such as a smart phone, Zigbee gateway or similar.

It is to be understood that in an embodiment the sensor device and the control unit may be part of the same device.

Turning to the embodiment shown in FIGS. 1a-c.

In FIG. 1a the valve 11 is positioned in the first valve position. In this position gas 3b may flow from the first container 5, through a first regulator 7, through a first tube 9 and then through the first valve inlet 11a, through the valve 11, out through the valve outlet 11c, further on through the third tube 12 and finally end up at the receiving unit 13, where it may be utilized for a specific purpose such as grilling.

As shown on FIG. 1b, when the amount of liquefied gas 3a in the first container 5 falls below a predetermined level (i.e. 1 kg), the vaporization of the liquified gas can no longer keep up with the gas usage of the receiving device 13, whereby the pressure and flow of the gas will drop.

The vaporization may depend on ambient temperature, gas container type and usage. Most gas container do however have same geometry so that the wetted surface area of the liquid is substantially the same whether it is a 5 kg container or a 10 kg container.

It is the sensor device, i.e. the weight 1, that in this embodiment determines a first sensed property; the weight of the remaining liquified gas 3a. This first sensed property indicates if the flow of gas to the receiving device is insufficient to the demand or usage of said device.

If this is the case, a control unit (not shown) changes the position of the valve 11 from the first position to the second position, wherein gas 4b may flow from the second container 6, through a second regulator 8, through a second tube 10 and then through the second valve inlet 11b, through the valve 11, out through the valve outlet 11c, further on through the third tube 12 and finally end up at the receiving unit 13. Hereby the receiving unit may continue its usage of gas uninterrupted.

The valve 11 is maintained in the second valve position for a specific period of time. This time period is in this specification referred to as a “re-vaporization period”.

In an embodiment the re-vaporization period is less than 20 minutes, preferably less than 10 minutes, more preferred less than 5 minutes, and most preferred no more than 1 minute.

In an embodiment the first re-vaporization period of the first container is less than the second re-vaporization period of the first container.

In a further embodiment the first re-vaporization period of the first container and/or the second re-vaporization period of the first container are/is less than the third re-vaporization period of the first container.

n an embodiment the re-vaporization period is determined by the control unit.

The control unit may use information from the measurement device and/or a second measurement device, so as to determine the length of the re-vaporization period and/or when the re-vaporization period is over.

During the re-vaporization period (some of) the remaining liquified gas 3a in the first container 5 is allowed to evaporate into new gas 3b, so that when the re-vaporization period is over, the pressure inside the first container is higher than the pressure inside said first container at the beginning of said re-vaporization period.

When the re-vaporization period is over, the control unit changes the valve 11 from the second valve position back to the first valve position, so that the newly vaporized gas in the first container may flow to the receiving unit 13.

Hereby the residual gas, that was not able to be used before the re-vaporization period, may now be used.

In an embodiment the measuring unit, shown as the weight 1, now again measures a second sensed property. The second sensed property is the weight of the now remaining liquified gas 3a.

When this second sensed property indicates that the flow of gas to the receiving device is insufficient to the demand or usage of said device, the controller changes the position of the valve 11 from the first position to the second position, enabling gas 4b to again flow from the second container 6 to the receiving device 13.

The valve 11 is maintained in the second valve position for a specific period of time. This time period is in this specification referred to as a “second re-vaporization period”.

In an embodiment the method comprises at least 3 re-vaporization periods, preferably more than 5 re-vaporization periods and most preferred more than 7 re-vaporization periods.

The changing of the valve and thus creation of re-vaporization periods may continue until the amount of liquified gas remaining in the first container 5 is less than 0.75 kg, preferably less than 0.5 kg or more preferred less than 0.1 kg.

The changing of the valve and thus creation of re-vaporization periods may continue until the pressure in the first container 5 is less than 1.0 bar, preferably less than 0.75 bar, preferred less than 0.5 bar, more preferred less than 0.35 bar or most preferred approximately 0.3 bar.

When the last drop of liquified gas has evaporated the pressure in the gas container is approximately 0.3 bar.

In an embodiment shown in FIG. 1a-c a method for optimization of residual gas usage in a gas delivery system comprises at least two containers 5, 6, the method comprising the steps of;
providing a first container 5 adapted to store liquified gas 3a,
providing a second container 6 adapted to store liquified gas 4a,
providing an at least three-way valve 11 adapted to change between a first valve position and a second valve position,
positioning said valve 11 in the first valve position, so that gas from the first gas liquid 3a flows from the first container 5 to a receiving device 13,
determining with a sensor device 31 a first sensed property, such as gas flow, said first sensed property indicating if the flow of gas to the receiving device 13 is below a predetermined level,
in case the flow of gas is below the predetermined level, the position of the valve 11 is changed to the second valve position, so that gas from the second gas liquid 4a flows from the second container 6 to the receiving device 13,
maintaining the valve 11 in the second valve position to allow the remaining first gas liquid 3a in the first container 5 to evaporate into new gas,
changing the position of the valve 11 back to the first valve position, so that the newly generated gas in the first container 5 may flow to the receiving device 13.

In an embodiment the method further comprising the steps of;
determining with the sensor device 31 a second sensed property, said second sensed property indicating if the flow of gas to the receiving device 13 is below a predetermined level,
in case the flow of gas is below the predetermined level, the position of the valve 11 is again changed to the second valve position, so that gas from the second gas liquid 4a flows from the second container 6 to the receiving device 13,
maintaining the valve 11 in the second valve position to allow the remaining first gas liquid 3a in the first container 5 to evaporate into new gas,
changing the position of the valve 11 back to the first valve position, so that the newly generated gas in the first container 5 may flow to the receiving device 13.

A control unit may be adapted to automatically change the position of the valve 11 between the first and second valve positions, preferably wirelessly, when the flow of gas is below the predetermined level, and/or when a predetermined amount of time has passed.

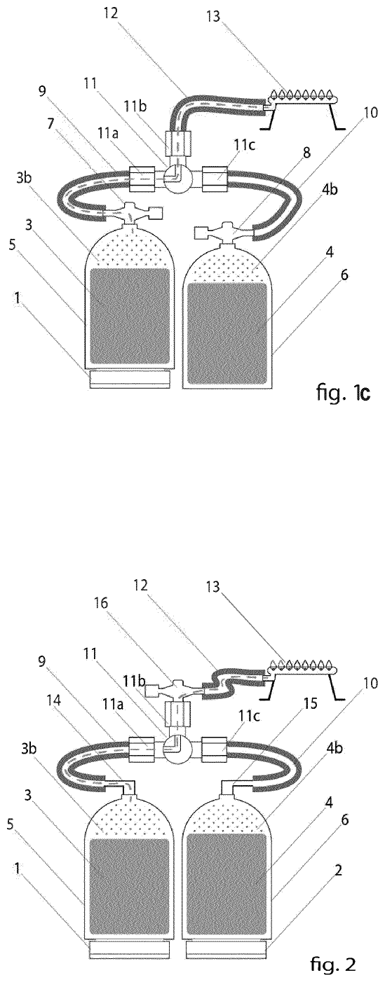

Turning now to FIG. 2 a second embodiment of a gas delivery system 100 of the invention is shown from a cross-sectional side view.

This embodiment may be especially advantageous for situations where high pressure systems/large amounts of gas are required, such as in industrial kitchens.

In this embodiment first gas container 5 is connected to the first tube 9 without a regulator in between. Likewise, the second gas container 6 is connected to the second tube 10 without a regulator in between (as seen on FIGS. 1a-d).

Instead the regulator 16 is positioned at the outlet 11c of the valve 11. This creates a high pressure system up until the regulator, since the pressure of the gas is not regulated until this point.

Hereby only one regulator 16 is necessary.

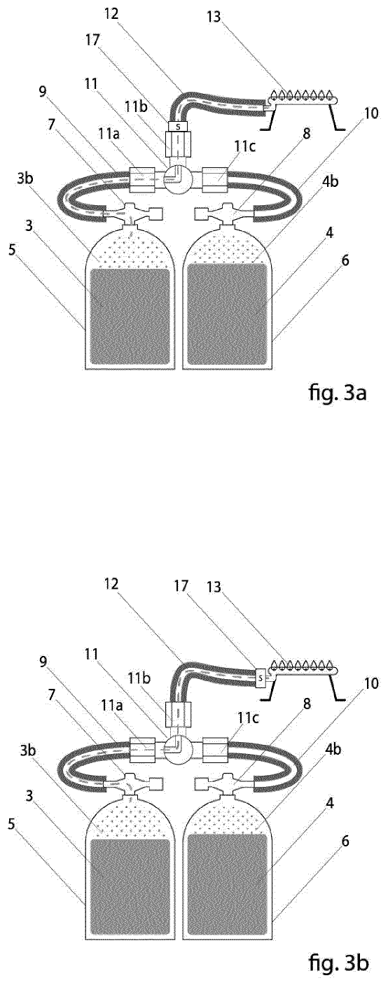

Turning now to FIGS. 3a-d which show different embodiments of a gas delivery system 100 of the invention from a cross-sectional side view, wherein a sensor 17, 18, 19 is shown at different positions on the system 100.

In FIG. 3a the third sensor 17 is positioned at the outlet 11a of the valve 11. The sensor may be a flow rate sensor for determining a sensed property, specifically a flow rate in the outlet 11c of the valve 11.

In FIG. 3b the third sensor 17 is positioned adjacent to the receiving unit 13. The sensor may be a flow rate sensor for determining a sensed property, specifically a flow rate of the gas right before said gas reached the receiving unit.

In FIG. 3c the third sensor 17 is positioned in connection with the third tube 12. The sensor may be a flow rate sensor for determining a sensed property, specifically a flow rate in the third tube 12.

In the shown embodiments only one or more sensors are necessary, thereby avoiding positioning one or more of the containers on weighing scales.

Furthermore it is also possible to arrange the sensor at a variety of different positions on/in the system 100.

Turning to FIGS. 4a-b different embodiments of a gas delivery system 100 of the invention from a cross-sectional side view with a control unit 20, 21 is shown.

In FIG. 4a. the control unit 20 is shown adjacent to the valve 11. The control unit 20 may be part of the valve 11.

The control unit 20 is adapted to receive, preferably wirelessly, a first sensed property, specifically a weight of the first gas container 5, from the first weighing scale 1.

The control unit 20 is also adapted to receive, preferably wirelessly, a second sensed property, specifically a weight of the second gas container 6, from the second weighing scale 2.

It will be understood that the control unit 20 may receive a plurality of sensed properties from each weighing scale 1, 2.

When the control unit 20 receives a first sensed property from first weighing scale 1, said
sensed property indicating that the amount of liquified gas 3a in the first gas container 5 is below a predefined threshold, wherein when the sensed property is below the predefined threshold the supply of gas to the receiving device 13 is insufficient, the position of the valve 11 is changed from the first valve position to the second.

When the control unit 20 receives a first sensed property from first weighing scale 1, said
sensed property indicating that the pressure in the first gas container 5 is below a predefined threshold, wherein when the sensed property is below the predefined threshold the supply of gas to the receiving device 13 is insufficient, the position of the valve 11 is changed from the first valve position to the second.

The valve 11 is thus maintained in the second valve position during a predefined re-vaporization period, so that residual gas 3b in the first container 5 may vaporize and create new gas. Hereby the pressure within the first container is higher at the end of the re-vaporization period than what it was at the beginning of said period.

The sensed property is provided by the sensor device. In this embodiment each of the weighing scales 1, 2 may be viewed as a sensor device adapted to detect a sensed property of their own.

FIG. 5 show an embodiment of a gas delivery system 100 according to the invention from a cross-sectional side view.

In this embodiment the system further comprises a separate control device 22.

Here the control device 22 is adapted to receive sensed properties from the first weighing scale 1 and/or the second weighing scale 2.

The control device 22 is further configured to generate a status signal based on the sensed property. This status signal may be a signal that indicates that the pressure in the gas container is below a predefined threshold, and/or that the weight of a gas container is below a predefined threshold, such that the supply of gas to the receiving device 13 is insufficient.

The control device 22 may transmit, preferably wirelessly, this status signal to the valve 11, which in response to said status signal changes position from and/or to the first valve position.

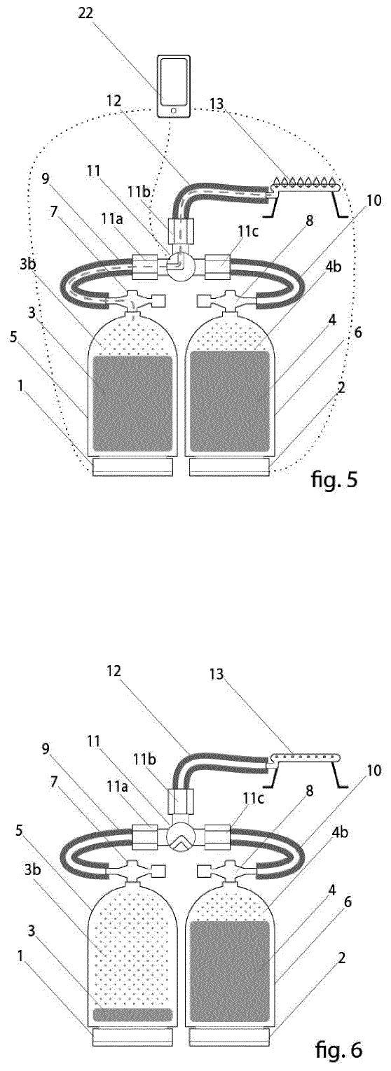

Turning to FIG. 6 where an embodiment of a gas delivery system 100 is shown from a cross-sectional side view.

In this embodiment the valve 11 is adapted to be arranged in a third valve position so that no gas may flow from the first gas container and/or the second gas container through the valve and onto the receiving unit 13.

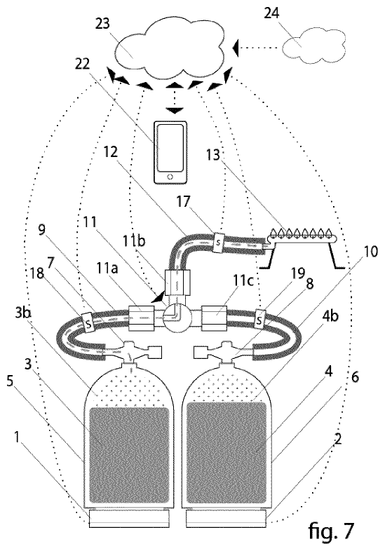

Lastly, FIG. 7 shows another embodiment of the gas delivery system 100.

Here the first sensor 18 is a flow rate sensor for determining a first sensed property, specifically a flow rate in the first tube 9 through which gas is supplied by the first gas container 5.

The second sensor 19 is a flow rate sensor for determining a second sensed property, specifically a flow rate in the second tube 10 through which gas is supplied by the second gas container 6.

Additionally, the third sensor 17 is a flow rate sensor for determining a third sensed property, specifically a flow rate in the third tube 12 through which gas is supplied from the valve 11 to the receiving device 13.

All sensors 17, 18, 19 and weighing scales 1, 2 are IoT and/or wirelessly connected to and/or controlled by a cloud based control system/program 23.

The system further comprises an IoT and/or wirelessly controlled valve 11.

Any one or more of the sensors 17, 18, 19 and/or weighing scales 1, 2 is adapted to send measuring information (e.g. a first sensed property) to the cloud 23.

The system 100 also comprises a control unit which may be part of the valve 11 or part of the cloud 23.

The control unit is configured to receive a sensed property related to the gas container.

The sensed property is provide by the sensor device. In this embodiment each of the sensors 17, 18, 19 and weighing scales 1, 2 may be viewed as a sensor device adapted to detect a sensed property of their own.

Each sensor or weighing scale being adapted to determine a sensed property, such as gas flow or weight.

The control unit is further configured to generate a status signal based on the sensed property. This status signal may be a signal that indicates that the pressure in the gas container is below a predefined threshold, wherein the supply of gas is insufficient to the receiving device 13.

If the control unit is part of the valve, then the control unit may transmit this status signal to the cloud.

The control unit may comprise one or more processors for receiving sensed property signals from the sensor devices and determine the status of the gas container(s) therefrom, and a communications module for communicating with the cloud 23 and/or a remote device 22 such as a smart phone.

The system further comprises a power management system for providing power to the one or more processors and/or to the communications module.

The control unit may be IoT managed, cloud managed or by an IfTTT-rule run by an app or Google™ Home.

The control unit and/or cloud may receive data 24 from other external sources, such as ambient temperature, weather forecasts and daily pricings on gas.

In this way it is possible for the system to determine/calculate the required length of each specific re-vaporization period.

Furthermore it will also be possible to automatically order a new gas container, when the first container is empty. Either via the cloud 23 or the remote device 22.

In an embodiment the valve, sensor(s) and control unit may be part of one device.

Also knowing the wetted surface of the gas container and the ambient temperature
an algorithm can calculate the time needed to build up pressure or how pressure changes according to gas phase consumption. The cloud/processor device will calculate and send a message to a valve when a bottle must be paused, to allow it to regain a equilibrium between gas phase and liquid phase. The cloud/processor will make the valve change to another bottle or set the valve in neutral, sending no gas from bottles to regulator and gas consuming products.

In one embodiment the system is adapted to provide a “pay per use/amount system”, such that when the amount of (pre) paid gas is used, the system will turn the valve to the third closed valve position (as shown in FIG. 6).

If for some reason the connection to the cloud or any of the wireless devices are cut off or unable to be established, the valve may be adapted to go to an automatic-mode, wherein the re-vaporization period is predefined to a certain time interval.

It will be readily understood that in this embodiment a sensor device 31 may comprise either one or each of the sensors and/or weighing scales.

By way of example, it will be readily appreciated that the system and/or valve and/or method could comprise a combination of two or more of the sensors, such as weight sensors, temperature sensors and flow rate sensors, or any combination thereof.

By way of further example, the system and/or valve and/or method may comprise an optical sensor for detecting when the valve is in the first valve position or in the second valve position.

In an embodiment a gas delivery system 100 for optimization of residual gas usage comprises;
the sensor device 31 is adapted to determine a second sensed property, such as gas flow, said second sensed property indicating if the flow of gas to the receiving device 13 is below a predetermined level, and wherein
the control unit 32 is adapted to change the position of said valve 11, when the flow of gas is below a predetermined level, from the first valve position to the second valve position, so that gas is directed from the second container 6 to the receiving device 13, wherein the control unit 32 is adapted to maintain the valve 11 in the second valve position to allow vaporization of new gas inside the first container 5, so that when a predetermined re-vaporization period, is reached, the control unit 32 is adapted to change the position of the valve 11 back to the first valve position, so that the newly generated gas in the first container 5 may flow to the receiving device 13, so as to optimize usage of the remaining liquid 3 in the first container 5.

In an embodiment of the gas delivery system 100, the sensor device 31 is adapted to determine a second sensed property, such as gas flow, said second sensed property indicating if the flow of gas to the receiving device 13 is below a predetermined level, and wherein the control unit 32 is adapted to change the position of said valve 11, when the flow of gas is below a predetermined level, from the first valve position to the second valve position, so that gas is directed from the second container 6 to the receiving device 13, wherein the control unit 32 is adapted to maintain the valve 11 in the second valve position to allow vaporization of new gas inside the first container 5, so that when a predetermined re-vaporization period, is reached, the control unit 32 is adapted to change the position of the valve 11 back to the first valve position, so that the newly generated gas in the first container 5 may flow to the receiving device 13, so as to optimize usage of the remaining liquid 3 in the first container 5.

While specific language has been used to describe the present subject matter, any limitations arising on account thereto, are not intended. As would be apparent to a person in the art, various working modifications may be made to the method in order to implement the inventive concept taught herein. The drawings and the foregoing description gives examples of embodiments. Those skilled in the art will appreciate that one or more of the described elements may well be combined into a single functional element. Alternatively, certain elements may be split into multiple functional elements, Elements from one embodiment may be added to another embodiment.

List of reference numbers

| | |
|---|---|
| 100 | Gas delivery system |
| 1 | First weighing scale |
| 2 | Second weighing scale |
| 3a | First liquified gas |
| 3b | First gas phase |
| 4a | Second liquified gas |
| 4b | Second gas phase |
| 5 | First gas container |
| 6 | Second gas container |
| 7 | First regulator |
| 8 | Second regulator |
| 9 | First tube |
| 10 | Second tube |
| 11 | Three-way valve |
| 11a | First valve inlet |
| 11b | Second valve inlet |
| 11c | Valve outlet |
| 12 | Third tube |
| 13 | Receiving device - such as a gas burner |
| 14 | First connecting part |
| 15 | Second connecting part |
| 16 | Third regulator |
| 17 | Pressure/flow sensor (at outlet of valve/at outlet of third tube) |
| 18 | Pressure/flow sensor (at first tube) |
| 19 | Pressure/flow sensor (at second tube) |
| 20 | Control unit (being part of valve) |
| 21 | Control unit (being part of weighing scale) |
| 22 | Remote control device (separate device - wireless communication) |
| 23 | Cloud based program/system |
| 31 | Sensor device |
| 32 | Control unit |

1. A method for optimization of residual gas usage providing an improved emptying of a gas container in a gas delivery system, said gas delivery system comprising;
a first and a second gas container for supplying gas, each container comprising liquified gas, and gas in gas phase and an at least three-way valve in fluid communication with the first and second gas containers, the valve being operable to change position between a first valve position, wherein gas in gas phase is supplied from the first container, and a second valve position, wherein gas in gas phase is supplied from the second container,
wherein the method comprises the steps of;
measuring with a sensor device a first sensed property of the gas phase in the first gas container,
receiving with a control unit the first sensed property from the sensor device,
changing the position of said valve from the first valve position to the second valve position based on the value of said first sensed property when said first sensed property is below a predetermined value, when vapourization of liquid gas can no longer keep up with the gas usage in a receiving device;
maintaining the valve in the second valve position for a re-vaporization period of time, said period being predefined by a predetermined threshold is reached which then enables the first gas container to again deliver stable pressure and flow above a minimum level that the receiving device consumes, said predetermined threshold being determined by detection of flow rate and/or pressure and/or based on a second sensed property from the sensor device, and
changing the position of the valve back to the first valve position after the re-vaporization period.

2. The method according to claim 1, wherein the first sensed property and/or the second sensed property is a gas flow measurement, a pressure, a temperature and/or a weight of the gas container.

3. The method of claim 1 further comprising;
measuring with the sensor device is adapted to measure a third sensed property of the first gas container,
receiving with the control unit the third sensed property from the sensor device,
changing the position of said valve from the first valve position to the second valve position based on said third sensed property;
maintaining the valve in the second valve position for a second re-vaporization period of time, said second re-vaporization period being predefined and/or based on a fourth sensed property from the sensor device, and
changing the position of the valve back to the first valve position after the second re-vaporization period.

4. The method of claim 1, wherein the position of the valve is changed at least two times, preferably at least 4 times, more preferred at least 6 times and most preferred a plurality of times until approximately all of the residual liquefied gas in the first gas container has evaporated.

5. The method of claim 1, wherein the first re-vaporization period is less than the second re-vaporization period, preferably the n re-vaporization period is less than the n+1 re-vaporization periods.

6. The method of claim 1, wherein the amount of residual, preferably liquified, gas in the first gas container at the beginning of any re-vaporization period is more, than the amount of residual, preferably liquified, gas in said first gas container at the end of said re-vaporization period.

7. The method of claim 1, wherein the control unit changes the position of the valve and/or the control unit is a separate control device adapted for wireless communication with the valve.

8. The method of claim 1, wherein the method is controlled by a cloud/IoT based programme.

9. (canceled)

10. A gas delivery system for optimization of residual gas usage, the system comprising;
a first and a second gas container for supplying gas;
an at least three-way valve in fluid communication with the first and second gas containers, the valve being operable to change position between a first valve position, wherein gas is supplied from the first container and a second valve position, wherein gas is supplied from the second container,
a sensor device adapted to measure a first sensed property of the first gas container,
a control unit configured to receive the first sensed property from the sensor device, and being adapted to change the position of said valve from the first valve position to the second valve position based on said first sensed property when said first sensed property is below a predetermined value;
wherein the control unit is adapted to maintain the valve in the second valve position for a re-vaporization period of time, said re-vaporization period being predefined and/or based on a second sensed property from the sensor device,
wherein the control unit is further adapted to change the position of the valve back to the first valve position after the re-vaporization period which then enables the first gas container to again deliver stable pressure and flow above a minimum level that the receiving device consumes, said predetermined threshold being determined by detection.

11. The gas delivery system according to claim 10, wherein the first sensed property and/or the second sensed property is a gas flow measurement, a pressure, a temperature and/or a weight of the gas container.

12. The gas delivery system according to claim 10, wherein—the sensor device is adapted to measure a third sensed property of the first gas container,
the control unit is configured to receive the third sensed property from the sensor device, and being adapted to change the position of said valve from the first valve position to the second valve position based on said third sensed property;
wherein that control unit is adapted to maintain the valve in the second valve position for a second re-vaporization period of time, said second re-vaporization period being predefined and/or based on a fourth sensed property from the sensor device,
wherein the control unit is further adapted to change the position of the valve back to the first valve position after the second re-vaporization period.

13. The gas delivery system according to claim 10, wherein the control unit is configured to change the position of the valve (11) at least two times, preferably at least 4 timers, more preferred at least 6 timers and most preferred a plurality of times until approximately all of the residual liquefied gas in the first gas container has evaporated.

14. The gas delivery system according to claim 10, wherein the first re-vaporization period is less than the second re-vaporization period, preferably the n re-vaporization period is less than the n+1 re-vaporization periods.

15. The gas delivery system according to claim 10, wherein the amount of residual liquified gas in the first gas container at the beginning of any re-vaporization period is more, than the amount of residual liquified gas in said first gas container at the end of said re-vaporization period.

16. A valve system for optimization of gas usage in a gas delivery system, said valve system comprising;
an at least three-way valve comprising:
a first inlet (11a) for receiving gas from a first container,
a second inlet (11b) for receiving gas from a second container,
an outlet for directing the gas from the first and/or second inlet to a receiving device,
wherein the valve (11) is adapted to change position between;
a first valve position, such that gas may flow from the first container through the valve to the receiving device, and
a second valve position, such that gas may flow from the second container to the receiving device,
said valve being positioned in the first position,
a sensor device adapted to determine a first sensed property, such as gas flow, said first sensed property indicating if the flow of gas to the receiving device is below a predetermined level,
a control unit adapted to change the position of said valve, so that in case the flow of gas is below the predetermined level, the control unit changes the position of the valve from the first valve position to the second valve position, so that gas is directed from the second container to the receiving device,
wherein control unit is adapted to maintain the valve in the second valve position to allow vaporization of new gas inside the first container, so that when a predetermined re-vaporization period is reached, the control unit is adapted to change the position of the valve back to the first valve position, so that the newly generated gas in the first container may flow to the receiving device.

17. The valve system according to claim 16, wherein the sensed properties are gas flow measurement, pressure, temperature and/or weight of the first gas container, and/or wherein the sensed properties are wirelessly transmitted to the control unit.

18. The valve system according to 16, wherein
the sensor device is adapted to measure a third sensed property of the first gas container,
the control unit is configured to receive the third sensed property from the sensor device, and is adapted to change the position of said valve from the first valve position to the second valve position based on said third sensed property,
the control unit is further adapted to maintain the valve in the second valve position for a second re-vaporization period of time, said second re-vaporization period being predefined and/or based on a fourth sensed property from the sensor device, and
wherein the control unit is further adapted to change the position of the valve back to the first valve position after the second re-vaporization period.

19. The valve system according to 16, wherein the control unit is configured to change the position of the valve at least two times, preferably at least 4 timers, more preferred at least 6 timers and most preferred a plurality of times until approximately all of the residual liquefied gas in the first gas container has evaporated.

20. The valve system according to 16, wherein the first re-vaporization period is less than the second re-vaporization period, preferably the n re-vaporization period is less than the n+1 re-vaporization periods and/or the amount of residual liquified gas in the first gas container at the beginning of any re-vaporization period is more than the amount of residual liquified gas in said first gas container at the end of said re-vaporization period.
